(19) United States
(12) Patent Application Publication
(10) Pub. No.: US 2021/0312736 A1
(43) Pub. Date: Oct. 7, 2021

(54) ACCESS SYSTEM

(71) Applicants: Josef Stephan ZEUS, Stilfs (IT); Oliver Erich Rudolf SCHUBERTH, Laas (IT); Kilian Günther ENGLERT, Schonungen (DE); Simon PEDROSS, Graun im Vinschgau (IT); HOPPE AG, Lana (IT)

(72) Inventors: Christian Josef Stephan Zeus, Stilfs (IT); Oliver Erich Rudolf Schuberth, Laas (IT); Kilian Günther Englert, Schonungen (DE); Simon Pedross, Graun im Vinschgau (IT)

(73) Assignee: HOPPE AG, Lana (IT)

(21) Appl. No.: 17/279,524

(22) PCT Filed: Sep. 24, 2019
(86) PCT No.: PCT/EP2019/075766

§ 371 Date: Jun. 9, 2021

(30) Foreign Application Priority Data
Sep. 24, 2018 (EP) 18196392.7

(51) Int. Cl. G07C 9/00; G06K 7/10

(52) U.S. Cl. CPC G07C 9/00944; G07C 9/00309; G06K 7/10336; G07C 2209/64; G07C 2009/00761; G07C 2009/00317; G07C 2209/08; G07C 2009/0096

(57) ABSTRACT

An access system (2) has a first actuation handle (6) that is attached to an outside of a door (4), a second actuation handle (8) that is attached to an inside of a door (4), and an access control system that has at least one evaluation unit (14), which is coupled to the at least one reader (10, 12) and is configured to identify a transponder that has been read. The system is characterized in that a first reader (10) is located on the outside of the door (4) and a second reader (12) is located on the inside of the door (4), and that the at least one evaluation unit (14) is configured to determine whether a transponder (16) read by the first reader (10) and/or the second reader (12) and identified by the at least one evaluation unit (14) is inside or outside the door (4), and to generate a door-opening signal if the identified transponder (16) is on the outside.

The invention relates to an access system, e.g. for opening a door or window, according to the preamble of claim 1.

Door panels and window sashes have a closing mechanism for securely and reliably closing building openings such as entries and windows against access from the outside or weather. The closing mechanism can be actuated from the inside with an actuation handle when the closing mechanism is not locked. Access from the outside is normally controlled, to prevent unauthorized persons from gaining access. This is achieved with conventional mechanical locks that have mechanical keys, or electromechanical locks, that also have electronic keys, so-called transponders, in the closing mechanism.

Electromechanical door locks are unlocked by a motor after a key (mechanical or electronic) has been recognized. For this, a key card or a keychain with a corresponding transponder must be held in front of or close to a reader. When a user is near the door or window, the electromechanical lock is released or unlocked when the transponder is recognized. This unlocking simply by approaching with a transponder is then only desired if someone is also exiting the building, or section of the building. This is not desired if a transponder is outside the building, but does not need access, or a transponder is inside the building, and there is no intention to exit. In this case, the electronic door lock is likewise unlocked when a transponder is recognized, even if there is no intention to enter or exit.

The object of the invention is therefore to create a system for checking access authorization that increases the reliability of the operation thereof.

The main features of the invention are described in the characterizing portion of claim 1. Embodiments are the subject matter of claims 2 to 14.

An access system is proposed that comprises a first actuation handle for attachment to an outside of a door, a second actuation handle that is to be attached to an inside of the door, and an access control system that contains at least one reader for reading a transponder, and at least one evaluation unit coupled to the at least one reader that is configured to identify a transponder that has been read. The access system is characterized in that there is a first reader that is placed on the outside of the door and a second reader that is placed on the inside of the door. The evaluation unit is also configured to determine whether a transponder that has been read by the first and/or second reader and identified in the at least one evaluation unit is on the inside or outside of the door, and, if the identified transponder is outside, to generate a door-opening signal.

An actuation handle is understood to be a mechanism for opening and closing a door or window. The first actuation handle on the outside of the door may differ from the second actuation handle on the inside of the door. It may be useful to use a rigid, non-moving first actuation handle on the outside. There can be a moving element in the second actuation handle on the inside. As a result, when the motorized lock or the like is unlocked, the door can be opened manually.

A reader is a device that can read transponders in a detection range determined by the reader. There are various radio signal technologies for this. The reader in question also has one or more antennas for this, and a radio circuit connected thereto. The reader can emit a continuous or cyclical radio signal with a strongly limited range. This range forms the respective detection range around the location where the reader is installed. If a transponder is within the detection range, i.e. the radio signal range of the reader, it can react to the emitted radio signal. The transponder can be passive for this, such that a circuit therein can be supplied with power by the radio signal and send a desired data set back to the reader. In this case, the detection range is normally small enough that the transponder has to be practically placed on the reader, or at least come very close to it. Active transponders can also be used that send out an identification immediately after receiving a radio signal, or respond to a radio signal after an input means is actuated, e.g. a button. To make this easier, the reader and the transponder can be coordinated such that a range of a few decimeters to somewhat more than one meter can be obtained. Consequently, a user can simply carry a transponder when approaching the door or the corresponding actuation handle.

The at least one evaluation unit can be an electronic device that can be configured to receive data input into the transponder and process this data for purposes of access control. Each reader can have its own integrated evaluation unit. The two evaluation units can then be coupled to one another, in order to be able to determine which side of the door the transponder is on. The coupling can be hardwired or wireless. It is also possible to use just one evaluation unit that is coupled to both readers. The evaluation unit can be placed on the inside of the door, entirely within the door, next to the door, or at some other central installation location in the building in question. For security reasons, it makes sense to not place the evaluation unit on the outside of the door.

The access control system therefore uses the first and/or second reader to read and identify a transponder in the proximity of the respective reader. This means that it is checked whether the transponder is a transponder previously known to the system and authorized for access. If such is the case, there is a fundamental authorization for opening the door.

According to the invention, prior to generating a door-opening signal for opening the door, a check is carried out to determine where an access-authorized transponder is located. The evaluation unit can be configured to ignore an access-authorized transponder on the inside. If the transponder is a transponder that is activated by pushing a button, or some other actuation, this may relate to a situation in which a transponder is still active and has already triggered a door signal for opening the door from the outside. If it is subsequently inside the door, it can no longer trigger a new door-opening signal. If instead, an access-authorized transponder approaches the outside of the door, it can trigger generation of a door-opening signal.

To determine the position of the transponder, it may make sense to determine the distance between the transponder and the two readers. With a subsequent comparison of the two distances, it becomes immediately clear which of the two readers is closer to the transponder in question. If the distance to the first reader is less than to the second reader, it can be assumed that the transponder is outside. If the distance to the second reader is shorter, it can be assumed that the transponder is inside the door.

The antennas and radio circuits in the readers should be identical for this distance measurement in order to prevent systemic errors. The distance can be determined by evaluating the measured field or signal strengths of the response signal from the transponder to the readers. Alternatively, a signal travel time between the respective reader and the transponder can be determined. If two independent evaluation units are used, each can be configured to measure a field strength or travel time. A single evaluation unit might be preferable, however, in order to prevent errors. It is also conceivable to equip each reader with a corresponding circuitry that enables distance measurement. The measured values from both evaluation units, or the distances determined therefrom, can be compared in one of the two evaluation units, or sent to another evaluation unit used only for this purpose. It may make sense to read a transponder with only one of the readers, and only use the other reader, in particular the second, to measure the distance to the transponder.

Consequently, the access system according to the invention form a very practical means for preventing an unintended opening of a door that can be locked via a motorized lock or the like.

The at least one evaluation unit is preferably configured to determine the distance by evaluating a measured signal strength or signal travel time for the response signal from the transponder to the readers.

The first reader and second reader are preferably coupled to the same evaluation unit. This reduces the complexity of the system. Furthermore, the location of the transponder can be determined directly in the shared evaluation unit by comparing field or signal strengths or signal travel times.

The heights at which the first and second readers are installed preferably differ by no more than 7 cm from one another. If the vertical offset of the two readers is too great, this could result in an imprecise determination of the location of the transponder. It would be possible for a transponder outside the door to be closer to the second reader than the first reader. This would result in the transponder being falsely determined to be located on the inside.

The installation heights of the first reader and second reader preferably differ by no more than 5 cm.

In an advantageous embodiment, the first reader is integrated in the first actuation handle. The construction of the access system according to the invention is therefore particularly slender and space-saving. Because door handles or similar items normally have hollow chambers, these can be used to accommodate a reader. The lengths of the wiring necessary for connecting or coupling the first reader consequently remain very short.

The first reader preferably has an active surface lying in a recess in the first actuation handle, and flush with the an outer surface of the actuation handle. The range, and therefore the detection range, can then be precisely set and implemented without interferences.

As a matter of course, the second reader can also be integrated in the second actuation handle, as explained below.

In another advantageous embodiment, a sensor for detecting an object located in a third detection range defined by the sensor, which is coupled to the at least one evaluation unit, is integrated in the first actuation handle, wherein the sensor is located on a first section of the first actuation handle, and the third detection range extends outward from the first section, and wherein the at least one evaluation unit is configured to activate the sensor to generate the door-opening signal, and first send the door-opening signal after detecting an object in the third detection range. The sensor is consequently placed in the actuation handle such that a third detection range is formed that extends outward from the actuation handle. The functioning of the sensor differs significantly from the functioning of the readers, and is only intended for detecting an object in the third detection range. The third detection range can preferably differ from the first detection range, in particular with regard to the spatial orientation thereof in relation to the actuation handle. If an object passes through it, e.g. a foot, a control command is input that can ultimately lead to opening the door. If the at least one evaluation unit decides that a transponder outside the door is allowed to open the door, the sensor is activated for actually initiating the opening of the door.

In an advantageous embodiment, the first actuation handle is at least partially rod-shaped, and has a first end and an opposing second end, wherein the first section is on the first end. The actuation handle can accordingly take the form of a rod handle or lever handle that extends more or less over the length of the door. These types of actuation handles are often vertical, such that a first end can be a lower end of such a rod handle, while the second end is located vertically above it. The first section can be located on the first end such that the first section and the first end are the same. If the first actuation handle is vertical, the sensor can be aimed downward. The third detection range can consequently extend to a floor in front of the door. If the first actuation handle is horizontal, for example, the third detection range can be transverse thereto, and aimed at the floor. Other variation are also possible, in which the third detection range and the orientation of the first actuation handle can be selected or set independently of one another.

The first actuation handle preferably has a main axis of extension, and the third detection range is parallel to this main axis of extension. The sensor is consequently preferably located on one end of the actuation handle, and is oriented such that a sensor axis is substantially parallel to the main axis of extension. An object that is to be detected must then pass through an extension of the main axis of extension at a distance to the end in question. This can relate in particular to a rod-shaped design for the first actuation handle.

The sensor can be an ultrasonic sensor in an advantageous embodiment. Such a sensor emits soundwaves in the ultrasonic range that are reflected by objects located in the third detection range. The distance to the object reflecting the soundwaves can be determined by determining a travel time for the reflected soundwaves. In certain installation situations, there can always be a floor or wall surface in the third detection range, that always reflects the soundwaves when the sensor is activated. The sensor, the at least one evaluation unit, or another superordinate component, can be configured by adjusting a circuit or programming, such that this reflection is not interpreted as the object that is to be detected. If another object moves into the third detection range, located between the sensor and the relevant wall or floor surface, the travel times are shorter. This temporary decrease in the travel time should then be interpreted as the object that is to be detected.

Other sensor variations can be used instead of an ultrasonic sensor. These can comprise a camera, infrared sensor, optical flow sensor, laser scanner, etc.

The sensor can at least partially extend out of the first actuation handle. The first actuation handle can have a recess or opening in the first section for this, into which the sensor fits. The detection behavior of the sensor can then be dictated exclusively by its structure, and is not limited by a potential installation situation. This extension also simplifies cleaning and servicing.

In a preferred embodiment, the first reader is located in a first housing, and forms a first assembly. The first reader can contain numerous individual components, e.g. a control unit, one or more antennas, signal electronics, etc. The first reader can be an electronic module, located, e.g., on a printed circuit board, which can be connected to external components via electrical lines. The first reader can be placed in a housing and encapsulated to protect the individual components, simplify assembly, and increase the durability thereof. The first reader then forms a single component that can be integrated, in particular, on or in the first actuation handle.

The reader is preferably cast in resin in the first housing. This results in a particularly high durability against external physical effects, such that a long service life is obtained.

In a preferred embodiment, the first reader fits into a hollow chamber in the first actuation handle. The first reader, or the first housing, is consequently sized such that the first housing can preferably be entirely inserted into the hollow chamber. This fit can be obtained by selecting an outermost cross section for the first reader that is slightly smaller than the cross section of the hollow chamber. By integrating it in the first actuation handle, the external appearance of the first actuation handle is not disrupted, and the first reader is very well protected mechanically.

In one advantageous embodiment, the sensor and first reader are connected to one another by a cable, wherein the cable has a branch that is connected to the second reader. The individual components can consequently be connected via a Y-shaped cable that extends from the sensor to the first reader and to the second reader. All of the components can be supplied with sufficient electricity via this cable. They can also be connected to a common evaluation unit and/or a motorized lock, or other components. The second reader can be coupled thereto directly, or indirectly via an intermediate component, i.e. the motorized lock.

The first actuation handle can also contain a lamp that emits light in the third detection range during the detection procedure. This can be used to indicate to a user that a gesture or the like is expected in the third detection range, to release or transmit the door-opening signal.

The lamp is preferably coupled to the sensor. Consequently, the lamp is only lit when the sensor is activated, and a corresponding input is expected. There is no need for a separate activation.

In a particularly advantageous embodiment, a lens focuses the light emitted from the lamp to form a light spot. A light spot can be generated by the focusing that is projected onto a floor or wall surface. The attention of a user can be directed toward the wall or floor surface by the light spot. The lens can be tinted or transparent. This allows a light spot with a diameter of up to 20 cm to be generated on the relevant surface, which can be readily seen. The light spot can preferably have a diameter of up to 12 cm. The lamp can also be designed such that the light spot can be seen in daylight. It is also advantageous to have a sharp contrast between the outline of the light spot and the background.

The lamp is particularly preferably configured to emit a cone of light. The third detection range preferably entirely encompasses the light cone.

The sensor and the lamp are preferably located in a second housing, and form a second assembly. Because the functions of the sensor and the lamp are coupled to one another in a preferred case, it makes sense to integrate these functions in a single assembly. The lamp can then be readily coupled directly to the sensor. The third detection range and a light cone emitted by the lamp can then be likewise easily adjusted to one another. The second assembly can be entirely encapsulated in order to be integrated into the first actuation handle. This simplifies assembly and reduces the steps necessary for obtaining electrical contact with the lamp.

The second housing also fits into a hollow chamber in the first actuation handle in an advantageous embodiment. Depending on the design thereof, this may be a rod handle or the like that is not solid, but instead is hollow. Because it is intended that the sensor and lamp are integrated in the first actuation handle, it may make sense to place these components directly in the hollow chamber. With an appropriate design for the second housing, it, or the second assembly, can be inserted entirely into the hollow chamber in the first actuation handle to secure it therein.

The second housing preferably has a groove for a sealing ring. The groove is preferably circumferential, and the sealing ring fits therein. Depending on the design of the first actuation handle, the groove and sealing ring may have different shapes.

There can be a projection window in the second housing. This can then be placed in front of the lens or the lamp, and allow light to pass through. The projection window can have a specific shape that affects the shape of the light spot in a desired manner.

The sensor can also have a sensor circuit that is configured to recognize a predefined movement from the sensor signals provided by the sensor. The sensor circuit could send a type of confirmation signal to the at least one evaluation unit, which then sends out the door-opening signal. Depending on the design of the sensor, more or less complex movement sequences can be detected. If the sensor is an ultrasonic sensor, which only measures a distance to an object, an object entering the third detection range for a short time can be recognized. This means that the sensor first detects no object in a detection time period, subsequently detects an object for a certain period of time, and subsequently no longer recognizes an object. This can correspond to the movement of a hand or foot through the third detection range. The sensor circuit is configured to send out a corresponding signal if such a movement is detected. It is not necessary to send out all of the unprocessed measurement data to the at least one evaluation unit.

In an advantageous embodiment, the first reader and/or the sensor are/is secured in a hollow chamber in the first actuation handle by clamping. Because of the clamping, no dedicated attachment devices are needed, and the cross section of the actuation handle can be selected within a wide range, without requiring a first reader and/or sensor of a different design. The housing encompassing the first reader or sensor can preferably be clamped in place. In a particularly advantageous case, the housing in question can have at least one threaded hole, into which a screw is screwed. By turning the screw such that it is screwed out of the threaded hole, the size of the housing and screw assembly can be increased. If the housing, along with the screw, are inside the first actuation handle, this clamps the housing securely therein. The screw can be actuated via a through hole in the first actuation handle. This is preferably on a side thereof that is not visible to a user when it has been installed on the door. Such a clamping embodiment has the advantage of simple assembly and removal. A step or a stop can also be formed in the first actuation handle, beyond which the relevant housing cannot be pushed into the hollow chamber. The alignment of the screw and the hole can thus be simplified.

In an advantageous embodiment, the first actuation handle consequently has through holes for inserting a tool into the hollow chamber to drive screws in order to clamp or release the first reader and/or sensor.

The second actuation handle, which is to be mounted on the inside of the door, can have a modular functional assembly with a mount to increase the flexibility of its design, which has numerous receiving sections for accommodating at least one bearing mechanism for a handle, at least one cladding element, and the second reader. The mount for the modular functional assembly can be understood to be a mechanical base that can accommodate different modules, and combine their functions in the form of a compact functional assembly. In order to accommodate the various modules, the mount has at least one receiving section for at least one module that is to be accommodated, and is positioned accordingly. The receiving sections can be depressions, recesses, projections, webs, flanges, holes, or similar features. Depending on what is desired, different second readers or bearings can be used that can be selected according to the desires of the customer, local preferences, or safety requirements, or depending on the motorized locks that are used.

The mount can be attached directly to the door, or via an adapter plate or the like. The at least one cladding element preferably covers the mount and all of the modules thereon, the second actuation handle has a pleasant outer appearance. The shape of the second actuation handle is not directly dependent on the size and design of the individual components when a mount and a cladding element that covers the mount are used.

The second actuation handle preferably has an opening through which a cable can be inserted on its attachment side, through which the second reader, located in the second actuation handle, can be connected to the first reader, among other things. Depending on the type and design of the first actuation handle and second actuation handle, and depending on the type and design of the at least one evaluation unit, a connection to an evaluation unit can also be obtained that is located in the second actuation handle or the first actuation handle, or some entirely different location at a distance thereto.

In an advantageous embodiment, the mount has a first hole for a drive pin that can be connected to the handle. The first hole allows a drive pin that is or can be connected to the handle to pass through the mount from one side. The bearing mechanism can then be placed on one side of the mount, and a drive pin can be pushed toward a side facing away from the handle. A motorized lock can be located there, with an entry for a drive pin. Depending on the design and arrangement of the individual components, there can also be a return spring or the like, that can be connected to the drive pin.

The bearing mechanism preferably has a bearing frame on which a pin bearing is located on at least one side, which extends outward from the bearing frame, and in which a first drive pin can be securely connected to the pin bearing. The bearing frame can be connected to the mount such that the bearing axis, i.e. the central axis of the pin bearing, is aligned with the central axis of the first section. The first drive pin can thus be connected to the pin bearing such that it cannot be removed from the pin bearing when pulled on. A handle can likewise be connected securely to the first drive pin. The first drive pin can have a polygonal cross section, as is the case with conventional drive pins in moving actuation handles, in particular a square cross section. By attaching the handle thereto, it can be supported by means of the pin bearing, and conduct torques toward the mount. The back of the pin bearing could contain a coupling section in a special case, configured to accommodate another drive pin. Alternatively, the first drive pin could be designed such that it extends entirely through the second actuation handle, and can be connected to a motorized lock on the outside thereof.

In a preferred embodiment, the bearing frame is a piece of sheet metal with multiple folds, wherein the first receiving section of the mount corresponds thereto, in order to accommodate the bearing frame such that it is flush thereto. There first receiving section could be a projection, in particular, which has at least in part a circumferential surface that fits to an inner contour of the bearing frame. Spring elements can also pass through the circumferential surface that are compressed when the bearing frame is slid or placed on it, thus exerting a tension against an inner surface of the bearing frame. The bearing frame could also have a ridge, at least in sections, that corresponds to recesses in an outer surface or circumferential surface of the projection, such that it snaps into these recesses when the bearing frame is slid or placed thereon. This results in at least a temporary retention of the bearing frame on the mount. A final attachment can be obtained with separate dedicated screws. Alternatively, screws can be used that tension or hold together the second actuation handle after all of the components have been snapped in place.

In an advantageous embodiment, the first receiving section forms a projection, and the bearing frame at least partially encompasses the first receiving section. As a result, at least part of the bearing frame is pulled snug against the first receiving section, and forms a mechanically robust assembly in the region of the first receiving section.

The pin bearing can have a radial surface to the central axis that is at least partially cylindrical, which extends from the bearing frame toward the handle. The actual bearing can be located inside this section, such that the entire bearing frame can be made from a single piece of sheet metal, resulting in an aesthetically pleasing appearance. Separate production and placement of a pin bearing and the securing thereof in the bearing frame is not necessary. The necessary number of components is therefore reduced, and the assembly is simplified.

The second reader can be placed on the side of the mount facing away from the handle. As a result it faces away from the operating side of the second actuation handle, and is therefore protected between the mount and the door, to which the second actuation handle is subsequently attached. An additional encapsulation of the second reader is therefore not necessary if the mount is sufficiently robust. This relates to the second actuation handle when it is installed on the inside of the door, where it is not particularly necessary for it to be watertight. The second reader could be used solely for measuring distances in one possible embodiment, as specified above.

The second actuation handle can be installed at a height that is typical or specified for ergonomic reasons. As a result, the first reader can be installed at a height on the outside of the door that is not substantially offset vertically to the height of the second reader. A horizontal offset should also be substantially avoided. This can normally be achieved in practice by placing the inner door handle and outer door handle at substantially aligned installation positions.

The second reader is preferably located above the first recess in the mount. With readers with a short range, a mark can be placed on the side facing the user, that the transponder is to be held against. When the second reader is placed above the first recess, the region facing the user and the installation location of the second reader are nearly aligned.

In an advantageous embodiment, the second actuation handle has an optical indicator, which is coupled to the second reader and/or the at least one evaluation unit, and is configured to output an optical indication when a transponder is read and/or identified. In particular, this can be placed along with the second reader on the same printed circuit board, and aimed at the handle. When an access-authorized transponder is identified, a light signal can be emitted. If the second reader is located above the first recess, the output light signal can consequently shine from the second actuation handle toward a surface above the handle facing the user, thus giving the user immediate feedback that the transponder has been identified.

It is also conceivable for the second actuation handle to have an (additional) optical indicator that is connected to the aforementioned sensor and is configured to give out an optical indication when the sensor is activated. It can also be coupled to the sensor by coupling it to the at least one evaluation unit, which outputs a corresponding signal for activating the sensor, i.e. the door-opening signal. The evaluation unit can also completely control the sensor, i.e. switch it on and off, and provide a signal or data connection.

The at least one cladding element preferably has a first cladding element, which entirely encompasses a surface facing the handle. The first cladding element can therefore function as a mechanical end of the second actuation handle.

The first cladding element can be made of a metallic material, and contain a window located above the bearing mechanism. The metallic design increases the mechanical durability against impacts and other unintentional or intentional effects. The detection range of the second reader is not shielded by the window, at least in a direction facing toward the user.

In an advantageous embodiment, the at least one cladding element has a second cladding element, which is made at least in part from a plastic and is located on a side of the first cladding element facing the handle. The plastic design can be used to cover the window without reducing the detection range, at least toward the user.

The mount is preferably made of plastic. Practically any shaped complex structure can be produced through injection molding, that is suitable for obtaining the receiving sections.

A return spring unit can be placed on a side of the mount facing away from the handle to return the handle from an actuated position to a neutral position. The return spring unit can form a compact packet, which can be placed on the mount as a module.

A cover is preferably placed as the outermost component on a side of the mount facing away from the handle, and fully encompasses the mount. The second actuation handle can therefore be screwed as a complete unit onto the door.

The cover can also have a threaded hole for at least one screw, which is inserted through the mount and at least one component facing the handle. The at least one component can be any of the aforementioned modules, comprising the bearing mechanism, reader, return spring unit, etc. The components can be held together by the screw passing through them.

It is also particularly advantageous if the at least one evaluation unit is configured to output an optical or acoustic indication when a transponder has been identified outside. This can be a blinking light or indicator sound, for at least a brief period of time.

The functioning of the evaluation unit shall be summarized below based on three different cases.

CASE 1: A first transponder is on the inside of the door, and a second transponder approaches the outside of the door.

It is assumed that the first transponder is located in the second detection range of the second reader. If the first transponder is a transponder that is activated by pressing a button, it is assumed that the first transponder is not (yet) activated, i.e. by a previous opening of the door. The first or second reader can then read in an identifier or other identification feature of the first transponder. It is then convenient to check for access authorization directly after this reading. This is obtained by comparing the identifier from the first transponder with predefined, i.e. stored, transponder identifiers. If the identifier from the first transponder is stored in a corresponding data set, the transponder is recognized as a being authorized for access. Subsequently, or simultaneously, the position of the first transponder is determined. It can be assumed here that the first transponder is located in a wide overlapping of the first and second detection ranges. If the first transponder on the inside is not located at an inner boundary of the second detection range at a distance to the door, it will probably also be within the first detection range. When a radio signal connection is established on both sides of the door, i.e. by the first reader and the second reader, a parameter for the distance can be obtained to determine the position of the transponder. This parameter is the field or signal strength of a signal sent from the first transponder to the readers, or the readers can each determine the distance by evaluating signal travel times. If such a parameter is obtained for each pair, comprising a reader and the first transponder, it is possible to figure out which side of the door the transponder is on through a comparison of these parameters. In this case, the evaluation unit determines that the transponder is on the inside. If a sensor for detecting an object in the third detection range is used, it is not activated.

When the second transponder then approaches the first actuation handle from the outside, it is read by one of the two readers, and preferably the first reader, and potentially identified as an access-authorized transponder. The second transponder can also preferably be read by the first reader in this example, when it is close enough. The position of the second transponder is detected by the aforementioned determination, indicating that the second transponder is on the outside, while the first transponder is located on the inside. If a sensor is used to detect an object in the third detection range, it is first activated by the approach of the second transponder, and the door can be opened by generating and transmitting a door-opening signal.

CASE 2: When there is no transponder inside, but a transponder approaches from the outside.

When the transponder is close enough to the first actuation handle, a transponder identifier is read in, and an attempt is made to identify the transponder. If the identification is successful, i.e. the transponder is authorized for access, a door-opening signal is generated for initiating the opening of the motorized lock. If a sensor is used to detect an object in the third detection range, it is then activated, and waits for actuation by a user. This can be combined with the activation of the lamp, such that the user is directly informed that a corresponding input is expected for sending the door-opening signal to the motorized lock.

CASE 3: There is only a transponder on the inside.

In this case, even if an access-authorized transponder is identified, a door-opening signal is not generated and output after the position of the transponder has been determined to be inside the door. The door can preferably be opened from the inside by actuating the second actuation handle, without a transponder.

Further features, details, and advantages of the invention can be derived from the wording of the claims and the following description of exemplary embodiments in reference to the drawings. Therein:

FIG. 1 shows an access system in a highly simplified schematic illustration;

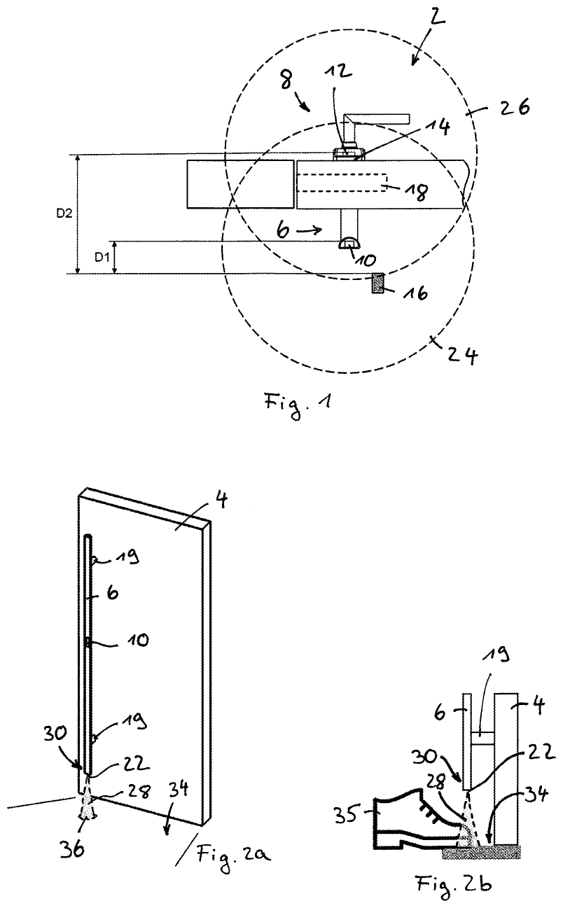

FIGS. 2a, 2b, and 2c a first actuation handle on a door;

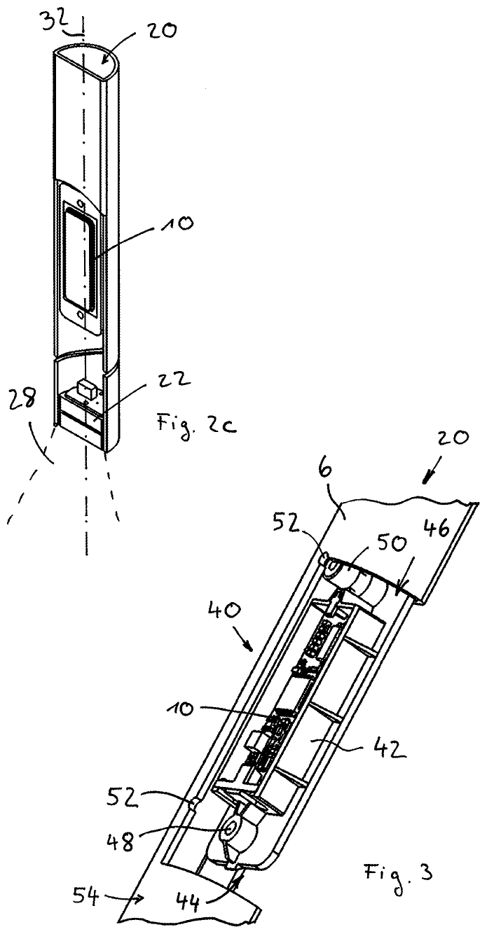

FIG. 3 shows a partially transparent section of a first actuation handle with a first reader integrated therein;

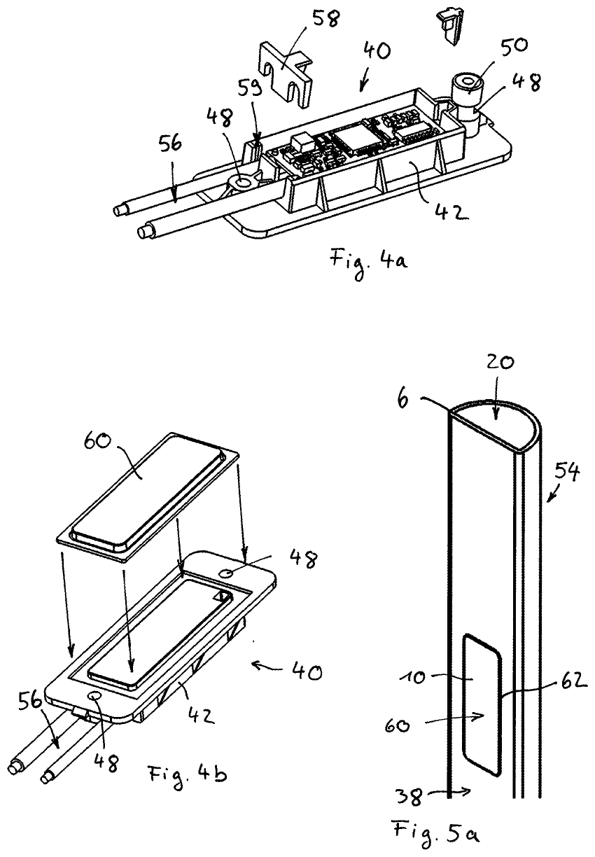

FIGS. 4a and 4b show a first reader with a housing and electrical lines in two different views;

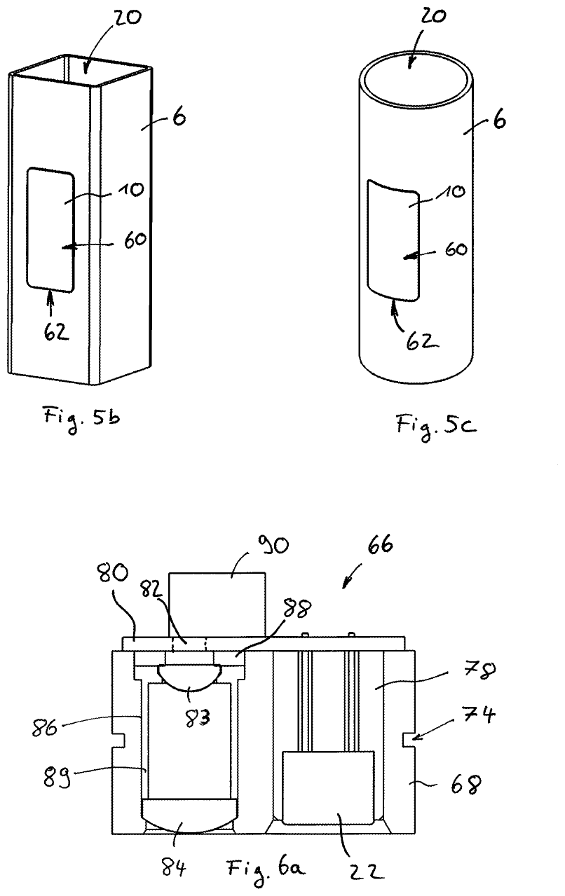

FIGS. 5a to 5c show different cross section variations for the first actuation handle in illustrations showing an active surface on the first reader;

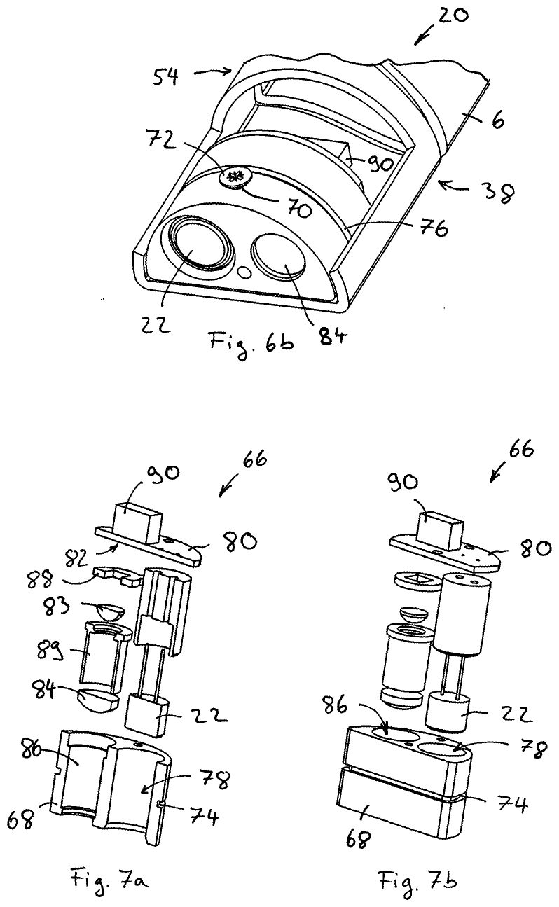

FIGS. 6a and 6b show a section of the first actuation handle with a sensor installed therein;

FIGS. 7a and 7b show an exploded view of a second assembly that has a sensor and a lamp;

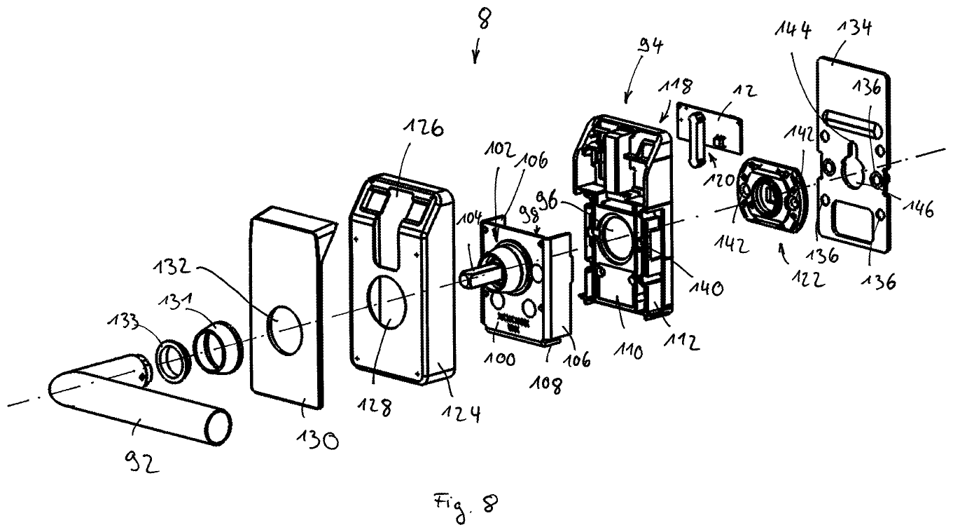

FIG. 8 shows an exploded view of a second actuation handle;

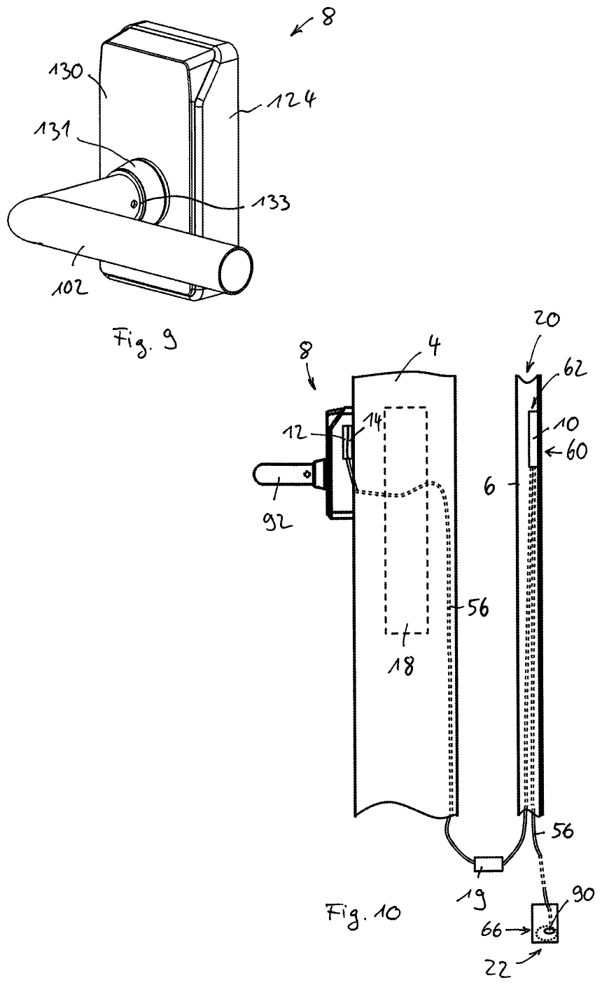

FIG. 9 shows an assembled second actuation handle; and

FIG. 10 shows an access system in another schematic illustration.

FIG. 1 shows a highly simplified schematic illustration of an access system 2 from above, on an upper surface of a door 4, on which a first actuation handle 6 is located on the outside and a second actuation handle 8 is located on the inside. Both actuation handles 6 and 8 are equipped with an access control system, which is not indicated in FIG. 1 as a single element, but instead is obtained through the interaction of the individual components. The first actuation handle 6 has a first reader 10, which is integrated directly in the first actuation handle 6, by way of example. The second actuation handle 8 also has a second reader 12, which is likewise integrated directly in the second actuation handle 8. There is also an evaluation unit 14, which is located by way of example in the second actuation handle 8.

The evaluation unit 14 is coupled to the first reader 10 and the second reader 12. It is configured to determine whether a transponder read by the first reader 10 and/or the second reader 12 and identified in the evaluation unit 14 is inside or outside the door 4. A door-opening signal is generated if an identified transponder is located on the outside. If the transponders are only located on the inside, the door-opening signal is not generated. The door is therefore only opened from the outside.

By way of example, a transponder 16 is shown, that is outside, and is within the detection ranges of both readers 10 and 12 due to the designs of the first reader 10 and second reader 12. The evaluation unit 14 is configured to determine a distance D1 from the first reader 10 to the transponder 16 and a distance D2 from the second reader 14 to the transponder 16. This can take place by determining a field or signal strength of a response signal sent from the transponder 16. By determining the distances D1 and D2, the evaluation unit 14 can determine whether the transponder 16 is outside or inside the door 4. If the distance D1 is less than D2, this indicates that the transponder is outside. If instead, the Distance D2 is less than D1, the transponder is very probably inside. At this point it should be noted that the evaluation unit 14 does not necessarily have to be able to calculate concrete distances. It is entirely sufficient to determine parameters based on the distance from the transponder 15 to the respective readers 10 and 12. These distance parameters can then be compared with one another.

The door-opening signal can be used to actuate a motorized lock 18, which is located directly in the door 4, for example. An expanded view of the access system 2 shall be shown in FIG. 10.

FIG. 2a shows an outside of the door 4 in the form of a house door, by way of example. The first actuation handle 6 is located thereon, which is in the form of a rod handle, and is perpendicular on the door 4. Transverse brackets 19 can be used to secure the first actuation handle 6 on the door 4. Two or more such brackets 19 can be used, which are distributed along the length of the first actuation handle 6. The first actuation handle 6 has a hollow chamber 20, indicated in FIG. 2c, in which the first reader 10 and a sensor 22 are located.

The first reader 6 and the sensor 22 are the components of an access control system located on the outside of the door 4 that allows an actuation of the motorized lock 18 or a similar mechanism from outside the door 4. The opening of the motorized lock is initiated by reading and identifying transponders 16 and subsequently detecting an object by the sensor 22.

To read a transponder, first reader 6 has a first detection range 24 in which a transponder carried by a user can be read. The second reader 12 shown in FIG. 1 has an analogous second detection range 26. These detection ranges can overlap more or less, depending on the design of the readers 10 and 12.

The sensor 22 has a third detection range 28 in which the presence of an object can be detected after identifying a transponder authorized for the opening on the outside of the door 4. The sensor 22 can be broadly understood to be an input means that can be triggered by a gesture with a foot or hand and is used for the actual activation of the opening of the motorized lock 18, either through releasing it or a confirmation for sending a door-opening signal generated by the evaluation unit 14.

In this illustration of the first actuation handle 6, the third detection range 28 can extend outward from a first end 30, which forms the first section of the first actuation handle 6. The third detection range is concentrated by way of example on a cylindrical, conical or club-shaped region extending outward from the sensor 22. A direction of extension for the third detection range 28 is generated by the orientation of the sensor 22, which is substantially aligned with a main axis of extension 32 of the first actuation handle 6. In this illustration, the third detection range 28 therefore extends from a lower end of the first actuation handle 6 to a floor 34 in front of the door 4. If an object enters this third detection range 28, shown as, e.g., a foot or shoe in a detail in FIG. 2b, it can be recognized by the sensor 22.

There is a lamp (not shown herein) for intuitively indicating the third detection range 28 and the activation of the sensor 22 to a user, which projects a light spot 36 onto the floor 34. The designs of the aforementioned components shall be explained in greater detail in reference to the following figures.

FIG. 3 shows a section of the first actuation handle 6, in which the first reader 10 is integrated. By way of example, the first actuation handle 6 has a cross section that is curved on one side but flat on the other. A curved side 54 can face the door 4 in the installed state, while the flat side 38 faces away from the door 4. As a matter of course, the first actuation handle 6 can also have some other cross section.

It is clear in this illustration that the first reader 6 forms a closed assembly, referred to below as the first assembly 40, which is integrated in the first actuation handle 6. This first assembly 40 has a first housing 42 encompassing the first reader 6. There are threaded holes 48 at the two ends 44 and 46, into which screws 50 are screwed. The first actuation handle 6 also has through holes 52 on its curved side 54 that are aligned with the threaded holes 48, through which a user can insert a tool for turning the screws 50. If the screws 50 are screwed out of the respective threaded holes 48, they bear on an inner surface of the first actuation handle 6 and consequently clamp the first housing 42 in the hollow chamber 20. This ensures not only that the first housing is secured in place, but also that it can be disassembled easily.

FIG. 4a shows an enlargement of the first assembly 40. It can be seen that the first housing 42 is significantly larger than is necessary to accommodate the first reader 10. Electrical connecting lines 56 are shown that extend outward from the interior of the first housing 42. By way of example, there are notches 59 for this, in which the connecting lines 56 are laid, and a clamp 58 that can be inserted into the first housing 42 to secure the connecting lines 56 to the first housing 42. The first housing 42 is filled with a casting resin to seal the first reader 10 and encapsulate the entire first assembly 40. As a result, the first reader 10 is irreversibly and completely encompassed by a watertight sheath, and reliably protected against external mechanical effects. During the casting process for the first housing 42, the clamp 58 seals the first housing 42. The first housing 42 can substantially form a basin, one side of which is open, and all other sides of which are, or can be, closed.

The first reader 10 can have a dedicated active surface 60, shown on a cover in FIG. 4b, which should be left uncovered as much as possible when integrated into the first actuation handle 6, in order to maintain a sufficient range. The active surface 60, which can also be referred to as the viewing surface, extends out of the first housing 42. It is advantageous if the active surface 60 lies in a corresponding recess in the first actuation handle 6.

FIG. 5a shows a subsection of the first actuation handle in a three dimensional illustration. A cut-out 62 can be seen in particular therein, which passes through the first actuation handle 6 on its flat side 38. The active surface 60 of the first reader can be inserted backwards therein. It should be noted here that the active surface 60 is preferably placed on the first assembly 40 such that the flat side 38 and the active surface 60 are flush to one another. This results in a harmonious surface design that does not disrupt the visual appearance of the first actuation handle 6.

There can also be an additional sealing ring 64 between the active surface 60 and the cut-out 62. The visible part of the sealing ring 64 at the cut-out 62 can be narrower than in the interior of the hollow chamber 20, such that it presses against the cut-out 62 from the inside when the first assembly 40 is clamped securely in place, but cannot pass through, due to the design, such that the sealing ring 64 appears to be flush therewith.

As explained above, the first actuation handle 6 can take various forms, which are shown in FIGS. 5b and 5c. FIG. 5b shows a first actuation handle 6 with a substantially square cross section. FIG. 5c shows a classic, entirely cylindrical cross section, as is often used for rod handles. Although the active surface 60 in the variations shown in FIGS. 5a and 5b can have the same design, the active surface 60 in the variation in FIG. 5c is curved.

FIGS. 6a and 6b show a second assembly 66, which is positioned at the first end 16 of the first actuation handle 6, and contains the sensor 22 placed therein. There is a second housing 68 for this, which fits into the hollow chamber 20 in the first actuation handle 6. It can therefore by slid into the actuation handle 6 through an opening in the first end 30. There is also a threaded hole 70 here for securing it, in which a screw 72 is placed. This is preferably a counter-sunk screw. The second housing 68 and therefore the second component 66 can be secured by this means in the hollow chamber 20 in the first actuation handle 6.

To seal the transition between the inner wall of the first actuation handle 6 and the second assembly 66, the second housing 68 has a circumferential groove 74 in which an appropriately shaped sealing ring is placed. It should be noted that the groove 74 and the sealing ring are designed such that the sealing ring is securely retained by the groove 74, such that it is not removed or sheared when the second assembly 66 is inserted into the hollow chamber 20. A sealing ring 76 is shown in FIG. 6b that is retained entirely in the groove 74, and bears on the inner surface of the hollow chamber 20.

The second assembly 66 is shown with the separate second housing 68 in an exploded view in FIGS. 7a and 7b. The second housing 68 has a first receiving space 78 for the sensor 22. This is placed on a printed circuit board 80, by way of example, which also contains a sensor evaluation circuit. A lamp 82 is also indicated by a broken line, which is likewise on the printed circuit board 80, next to the sensor 22. This lamp 82 can be electrically coupled to the sensor 22 or the printed circuit board 80, such that when the sensor 22 is activated, the lamp 82 is also on, and emits light.

There is a lens 84 for focusing the light, which can be placed in a second receiving space 86. This is placed next to the first receiving space 78 in the second housing 68. When the sensor 22 and the lens 84 are placed in the associated receiving spaces 78 and 86, the printed circuit board 80 is flush with the second housing 68. The lamp 82 can be a light emitting diode soldered onto the printed circuit board 80, which already has a first lens 83. By way of example, this can be placed in a mount 88 on the printed circuit board 80. The lens 84, mount 88 and first lens 83 can be preassembled in a lens tube 89.

By way of example, an electrical connector 90 is placed on the printed circuit board 80 on a side facing away from the sensor 22 and the lamp 82. The connector 90 can be coupled to the evaluation unit 14 in particular, or a similar superordinate system. The printed circuit board 80 can already have a sensor evaluation circuit that controls the sensor 22 and the lamp 82, and in particular evaluates signals or data from the sensor 22. The sensor evaluation circuit is preferably configured to detect an object in the third detection range from the raw signals. A signal can then be provided via the electrical connector 90 indicating that a corresponding object has been detected. As a result, it is not necessary to send all of the signals from the sensor 22 to a superordinate unit to be processed there.

FIG. 8 shows the second actuation handle 8 in an exploded view. By way of example, there is a handle 92 for operating it, which forms a right angle and can be operated like a conventional door handle.

The second actuation handle 8 preferably, and by way of example, has a modular construction, wherein a mount 94 forms a core component. This can be made of plastic, for example, and is intended for receiving other various components, such that they form a modular functional assembly. The mount 94 has a first hole 96, through which a drive pin can extend.

First, there is a bearing mechanism 98, which has a bearing frame 100 on which a pin bearing 102 is located for supporting a first drive pin 104. The bearing frame 100 can be made from a piece of sheet metal that is bent multiple times. The bending forms two substantially parallel lateral tabs 106. There is a base tab 108 at the bottom surface, which substantially runs between the two lateral tabs 106, at a right angle thereto. The tabs 106 and 108 do not need to be connected to one another.

A first receiving section 110 on the mount 94 forms a projection with two lateral surfaces 112, which correspond to the lateral tabs 106. The bearing frame 100 can therefore by placed on the first receiving section 110, such that both lateral tabs 106 are slid or placed on the two lateral surfaces 112 of the mount 94. With an appropriate design, e.g. a ridge, spring elements, or other features, an at least temporary form- or force-fitting connection can be obtained between the bearing frame 100 and the mount 94.

The pin bearing 102 extends outward from the bearing frame 100. It has a radial cylindrical surface 116 running about a central axis 114, extending from the bearing frame 100 toward the handle 92. The pin bearing 102 is delimited or formed by the cylindrical surface 106. A corresponding roller bearing with a cylindrical outer surface can be placed and secured in the hollow chamber encompassed by the cylindrical surface 116. The first drive pin 104 can be retained axially on the pin bearing 102 such that cannot be displaced using appropriate means, not shown herein.

There is a second receiving section 118 in the form of a recess on a side of the mount 94 opposite the bearing mechanism 98. The second receiving section 118 can accommodate the second reader 12, which is located above the central axis 114 and in particular above the bearing mechanism 98. The second reader 12 then lies above the bearing mechanism 98 and in a side of the mount 94 facing away from it. As specified above, it may be useful for the installation heights of the first reader 10 and second reader 12 to be substantially the same.

By placing the second reader 12 on a side of the mount 94 facing away from the handle 92 and the bearing mechanism 98, the second reader 12 is protected against mechanical damage. The second reader 12 has an electrical connecting line 120, for example, which shall be explained in greater detail below.

In order to enable the normal movement of the handle 92, there is a return spring unit 122. This contains a spring packet in particular, not shown in greater detail, that acts against a turning of the first drive pin 104 by the handle 92. The return spring unit 122 can be connected to a second drive pin (not shown). The first drive pin 104 can also be designed such that it extends into or beyond the return spring unit 122. The design of the details can be selected freely according to normal standards in the field. It is also conceivable that the bearing mechanism 98 has a coupling for coupling to the first drive pin 104 on a side facing away from the handle 92. Ultimately, a connection should be obtained to a motorized lock or lock mechanism, not shown, with the first drive pin 104 or a second drive pin.

There is a first cladding element 124 on a side of the mount 94 facing the handle 92, which is made of metal, for example. To ensure that the second reader 12 has an optimal detection range, the first cladding element 124 has a window 126 on a side lying above the central axis 114. This forms an opening that is aligned with the orientation of the second reader 12. On the whole, the first cladding element 124 forms a basin, such that the mount 94 is fully encompassed with the bearing mechanism 98, and covered toward the exterior. As a matter of course, there is a second hole 128, through which the pin bearing 102 extends outward. The frame 94 and the first cladding element 124 are wedge-shaped in the region of the window 126.

To fully conceal it visually, there is a second cladding element 130, which is made of plastic in particular. The plastic does not interfere with radio signals transmitted between a transponder and the second reader 12. The second cladding element 130 is placed on a side of the first cladding element 134 facing the handle 92, and has a third hole 132, through which the pin bearing 102 can extend outward. An escutcheon 131 can also cover the pin bearing 12. A tolerance sleeve 133 can adjoin this, through which the handle 4 can be guided.

There is also a cover 134 on a rear surface of the second actuation handle 8, which extends along the surface of the mount 94. Numerous threaded holes 136 are located therein, which can accommodate screws (not shown here). These screws can extend through holes 138 in the bearing mechanism 98, holes 140 in the mount 98, and holes 142 in the return spring unit 122, and be screwed into the threaded holes 136. As a result, all of the components are securely connected to one another. There is an opening 144 for the connecting line 120, e.g. in the form of a notch. This adjoins a fourth hole 146, through which a drive pin passes.

FIG. 9 shows the second actuation handle 8 in the assembled state. It can be seen therein that the pin bearing 102 extends from the second cladding element 130, and the handle 92 is flush therewith.

FIG. 10 shows another schematic illustration of the access system 2 in FIG. 1, taking the components shown in FIGS. 2a to 9 into account. The door 4 is shown here with the first actuation handle 6 and the second actuation handle 8. A motorized lock 18 is located in the door 4, as already indicated in FIG. 1. The motorized lock 18 can be supplied with electricity via a cable integrated in the door, and not shown herein. This cable can be integrated in the door 4 during assembly, and connected to a building power supply via a corresponding connecting element, e.g. on or next to a door hinge.

The wiring shown in FIG. 10 can be used to power the components of the access system 2 with electricity. The first reader 10 is integrated in the hollow chamber 20 in the first actuation handle 6. The connecting lines 56 shown in FIG. 4 extend downward in the hollow chamber 20, by way of example, and are each branched. The connecting lines 56 form a Y-shaped assembly. One of the two connecting lines 56 is connected to the second assembly 66, or the sensor 22. The sensor 22 can be supplied with electricity by these connecting lines 56. A data or signal transfer to the first reader 10 can also be obtained therewith.

The second connecting line 56 likewise passes downward through the hollow chamber 20, and can extend via a bracket 19 into the door 4 and to the motorized lock 18 therein. This variation is of particular interest if the first actuation handle 6 has a rod-shaped handle that is attached at points that are relatively far from the installation height for the first reader 10. By guiding the connecting lines 56 into the motorized lock 18, the first reader 10 and the sensor 22 can then be supplied with electricity. A connection to the second reader, or the evaluation unit 14 exclusively located in the second actuation handle 8, by way of example, can also be obtained. As a result, all of the components are connected to one another, in order to fulfill the objective of the access system 2.

The signal or data connection between the evaluation unit 14 and the first reader 10, or the sensor 22 or other components in the second assembly 66, does not necessarily have to be a hardwired connection. It is also conceivable to use wireless connection, due to the preferably permanent power supply to both actuation handles 6 and 8. Corresponding transmitter and receiver modules can be used for this. This reduces the complexity of the door construction, or the wiring for the motorized lock 18 and can also be obtained by upgradable radio signal modules that can be integrated in the actuation handles 6 and 8. These can also form a simple connection to a bus or communication system installed in the building. It is also easy to place the evaluation unit 14 somewhere else, at a distance to the actual actuation handles 6 and 8.

The invention is not limited to the embodiments described above, and instead can be used in a number of ways.

All of the features, advantages, including constructive details, spatial arrangements and method steps that can be derived from the claims, description, and drawings, may be substantial to the invention in and of themselves or in various combinations thereof.

List of Reference Symbols

| | |
|---|---|
| 2 | door |
| 4 | actuation handle |
| 6 | first actuation handle |
| 8 | second actuation handle |
| 10 | first reader |
| 12 | second reader |
| 14 | evaluation unit |
| 16 | transponder |
| 18 | motorized lock |
| 19 | bracket |
| 20 | hollow chamber |
| 22 | sensor |
| 24 | first detection range |
| 26 | second detection range |
| 28 | third detection range |
| 30 | first end/first section |
| 32 | main axis of extension |
| 34 | floor |
| 35 | object |
| 36 | light spot |
| 38 | flat side |
| 40 | first assembly |
| 42 | first housing |
| 44 | one end of the first housing |
| 46 | another end of the first housing |
| 48 | threaded hole |
| 50 | screw |
| 52 | through hole |
| 54 | curved side |
| 56 | electrical connecting line/cable |
| 58 | clamp |
| 59 | notch |
| 60 | active surface |
| 62 | cut-out |
| 64 | sealing ring |
| 66 | second assembly |
| 68 | second housing |
| 70 | threaded hole |
| 72 | set screw |
| 74 | groove |
| 76 | sealing ring |
| 78 | first receiving space |
| 80 | printed circuit board |
| 82 | lamp |
| 83 | first lens |
| 84 | lens |
| 86 | second receiving space |
| 88 | mount |
| 89 | lens tube |
| 90 | electrical connector |
| 92 | handle |
| 94 | mount |
| 96 | first hole |
| 98 | bearing mechanism |
| 100 | bearing frame |
| 102 | pin bearing |
| 104 | first drive pin |
| 106 | lateral tab |
| 108 | base tab |
| 110 | first receiving section |
| 112 | lateral tab |
| 114 | central axis |
| 116 | cylindrical surface |
| 118 | second receiving section |
| 120 | electrical connecting line |
| 122 | return spring unit |
| 124 | first cladding element |
| 126 | window |
| 128 | second hole |
| 130 | second cladding element |
| 131 | escutcheon |
| 132 | third hole |
| 133 | tolerance sleeve |
| 134 | cover |
| 136 | threaded hole |
| 138 | hole |
| 140 | hole |
| 142 | hole |
| 144 | opening |
| 146 | fourth hole |

1. An access system (2) that has a first actuation handle (6) for attachment to an outside of a door (4), a second actuation handle (8) for attachment to an inside of the door (4), and an access control system that has at least one reader (10, 12) for reading a transponder (16), and at least one evaluation unit (14), which is coupled to the at least one reader (10, 12) and is configured to identify a transponder that has been read, characterized in that a first reader (10) is placed on the outside of the door (4) and a second reader (12) is placed on the inside of the door (4), and that the at least one evaluation unit (14) is configured to determine whether a transponder (16) read by the first reader (10) and/or the second reader (12) and identified in the at least one evaluation unit (14) is inside or outside the door (4), and to generate a door-opening signal if the identified transponder (16) is on the outside.

2. The access system (2) according to claim 1, characterized in that the at least one evaluation unit (14) is configured to determine the distance by evaluating a measured signal strength or signal travel time of a response signal from the transponder to the readers (10, 12).

3. The access system (2) according to claim 1, characterized in that the first reader (10) and the second reader (12) are coupled to the same evaluation unit (14).

4. The access system (2) according to claim 1, characterized in that the installation heights of the first reader (10) and the second reader (12) differ by no more than 7 cm.

5. The access system (2) according to claim 1, characterized in that the first reader (10) is integrated in the first actuation handle (6).

6. The access system (2) according to claim 1, characterized in that a sensor (22) for detecting an object (35) located in a third detection range (28) defined by the sensor (22), which is coupled to the at least one evaluation unit (14), is integrated in the first actuation handle (6), wherein the sensor (22) is located on a first section (32) of the first actuation handle 86), and the third detection range (28) extends outward from the first section, and wherein the at least one evaluation unit (14) is configured to activate the sensor (22) to generate a door-opening signal, and transmit the door-opening signal after first detecting an object (35) in the third detection range (28).

7. The access system (2) according to claim 6, characterized in that the first actuation handle (6) is at least partially rod-shaped, has a first end (32) and an opposing second end, wherein the first section (32) is on the first end (32).

8. The access system (2) according to claim 6, characterized in that the first actuation handle (6) has a main axis of extension (32) and the third detection range (28) is parallel to the main axis of extension (32).

9. The access system (2) according to claim 6, characterized in that the sensor (22) is an ultrasonic sensor.

10. The access system (2) according to claim 4, characterized in that the first reader (10) is located in a first housing (42) and forms a first assembly (40).

11. The access system (2) according to claim 6, characterized in that the sensor (22) and the first reader (10) are connected to one another via a cable (56), wherein the cable (56) has a branch coupled to the second reader (12).

12. The access system (2) according to claim 6, characterized in that the first actuation handle (6) also has a lamp (82), which emits light in the third detection range (28) during the detection procedure.

13. The access system (2) according to claim 12, characterized in that the lamp (82) is coupled to the sensor (22).

14. The access system (2) according to claim 1, characterized in that the at least one evaluation unit (14) is configured to output an optical or acoustic indication when a transponder (16) on the outside has been identified.
